(19) United States
(12) Patent Application Publication
(10) Pub. No.: US 2024/0175150 A1
(43) Pub. Date: May 30, 2024

(54) POROUS NANOSHEET AND MANUFACTURING METHOD THEREOF

(71) Applicant: Industry-Academic Cooperation Foundation, Yonsei University, Seoul (KR)

(72) Inventors: Seong-Ju Hwang, Seoul (KR); Jihyeong Lee, Seoul (KR)

(21) Appl. No.: 18/529,954

(22) Filed: Dec. 5, 2023

(30) Foreign Application Priority Data
Oct. 5, 2022 (KR) 10-2022-0126923

(51) Int. Cl. C25B 11/091; C25B 1/04; C25B 11/031

(52) U.S. Cl. CPC C25B 11/091; C25B 1/04; C25B 11/031

(57) ABSTRACT

Provided are a porous nanosheet and a method for manufacturing the same, and a porous nanosheet which may include holes on the surface while maintaining a two-dimensional nanosheet form and may significantly improve catalyst efficiency and economic feasibility while minimizing platinum usage by introducing a platinum single atom to the holes, and a method for manufacturing the same are provided.

### CROSS-REFERENCE TO RELATED APPLICATIONS

This application claims priority under 35 U.S.C. § 119 to Korean Patent Application No. 10-2022-0126923, filed on Oct. 5, 2022, in the Korean Intellectual Property Office, the disclosure of which is incorporated herein by reference in its entirety.

### TECHNICAL FIELD

The following disclosure relates to a porous nanosheet and a method for manufacturing the same, and more particularly, to a porous nanosheet which may include holes on the surface while maintaining a two-dimensional nanosheet form and may significantly improve catalyst efficiency and economic feasibility while minimizing platinum usage by introducing a platinum single atom to the holes, and a method for manufacturing the same.

### BACKGROUND

Fossil fuel usage has continued to increase due to an increase in world population, and the fossil fuel emits substances which adversely affect global warming such as carbon dioxide and has a problem of depleting reserves. Thus, a study of energy resources to replace the fossil fuel has continued. Accordingly, hydrogen which has high energy density and is environmentally friendly was introduced as a substitute for fossil fuels, and an electrochemical catalyst material used for hydrogen production uses platinum, but since platinum has a disadvantage of having low energy efficiency and being expensive, development of an electrochemical catalyst which is easily available and has high activity so that the platinum may be replaced is needed.

Meanwhile, molybdenum disulfide (MoS₂) is an inorganic compound consisting of molybdenum and sulfur and is classified as a transition metal chalcogen compound. The molybdenum disulfide as such has an indirect band gap when it is in bulk, but when it is peeled off as a single layer, it shows semiconductor properties having a direct band gap, and a study for using it as a catalyst of a hydrogen evolution reaction by replacing platinum due to a surface active site at which hydrogen may react continues.

However, since the electrochemical catalyst using molybdenum disulfide has the following problems, it is difficult to use it as a catalyst of a hydrogen evolution reaction.

First, since the electrochemical catalyst using molybdenum disulfide has low electroconductivity, movement and diffusion of electrons and ions are not smooth, and thus, catalytic activity is not sufficient. In order to solve the problem, a technique of mixing the molybdenum disulfide and a metal having excellent electroconductivity to manufacture a catalyst is introduced, but in this case, electroconductivity is improved, but the structural stability of the catalyst is greatly deteriorated by mixing two materials and electrochemical stability is not secured.

Second, though a metal is introduced to molybdenum disulfide to secure even structural/electrochemical stability, when the molybdenum disulfide and the metal are manufactured into a nano-sized sheet form, a reaction site at which hydrogen may react is not sufficient, so that catalytic activity may not be sufficiently secured. That is, it was reported that since a surface active site at which a molybdenum disulfide metal nanosheet may react as a catalyst may not be sufficiently secured, efficiency to an electrochemical catalyst may not be sufficiently secured.

Third, as a method for manufacturing the molybdenum disulfide and the metal into a nano-sized sheet form, a method of introducing a metal single atom to a two-dimensional nanosheet to which holes are introduced was introduced, and in this case, all atoms in a metal single atom form may function as a surface active site, and thus, very high activity per weight may be shown. In general, for optimal performance of a single atom catalyst, substrates need conditions such as high electroconductivity, a rapid ion diffusion rate, strong bonding with a single atom, and chemical stability. However, since a metal single atom state has high surface energy, it agglomerates easily. That is, in order for a metal single atom to show optimal catalyst performance, the metal single atom should provide many surface active sites without agglomeration, but since the agglomeration as such may not be prevented, the excellent catalyst properties unique to the metal single atom may not be sufficiently used.

Accordingly, excellent electrochemical properties as a catalyst may be secured by implementation into a sheet form, and also, catalyst efficiency may be significantly improved by increasing a surface active site, and furthermore, a study of a highly efficient electrochemical catalyst which may secure both structural stability and electrochemical stability is urgently needed.

### RELATED ART DOCUMENTS

### Patent Documents

(Patent Document) Korean Patent Laid-Open Publication No. 2018-0090590 (Aug. 13, 2018)

### SUMMARY

An embodiment of the present invention is directed to providing a porous nanosheet which may include holes on the surface while maintaining a two-dimensional nanosheet form and may significantly improve catalyst efficiency and economic feasibility while minimizing platinum usage by introducing a platinum single atom to the holes, and a method for manufacturing the same.

In one general aspect, a method for manufacturing a porous nanosheet includes: a first step of manufacturing a MoS₂ nanosheet; a second step of heat-treating the MoS₂ nanosheet under a nitrogen atmosphere to manufacture a MoN nanosheet; and a third step of reacting the MoN nanosheet with a solution including platinum to manufacture a Pt—MoN nanosheet to which platinum is introduced.

In addition, according to an exemplary embodiment of the present invention, the MoS₂ nanosheet of the first step may be characterized in that it is formed by laminating a plurality of MoS₂ nanosheet precursors with a material including an organic cation.

In addition, the second step may be characterized by heat-treating the MoS₂ nanosheet with an ammonia gas at a temperature of 700 to 900° C.

In addition, the second step may be characterized by forming holes by the heat treatment.

In addition, the third step may be characterized as a step of stirring the MoN nanosheet with a H₂PtCl₆ aqueous solution at a temperature of 60 to 80° C. for 1 to 3 hours.

In addition, the third step may be characterized as a step of manufacturing a Pt—MoN nanosheet to which a platinum single atom is introduced by a substitution reaction between a platinum (Pt) ion and a molybdenum (Mo) ion of MoN.

In another general aspect, a porous nanosheet in which holes are included on the surface and a platinum atom is introduced to a part of the holes is provided, as a MoN nanosheet.

In addition, according to an exemplary embodiment of the present invention, the porous nanosheet may be characterized in that an XRD 2-theta value by a platinum single metal is not shown.

In still another general aspect, an electrochemical catalyst includes the porous nanosheet described above.

In addition, the electrochemical catalyst may be an electrochemical catalyst characterized by being used as a catalyst in a hydrogen evolution reaction (HER).

Since the present invention may include holes on the surface while maintaining a two-dimensional nanosheet form and may significantly improve catalyst efficiency and economic feasibility while minimizing platinum usage by introducing a platinum single atom to the holes, a catalyst which is more economical and has better efficiency than currently commercially available Pt/C may be manufactured.

### BRIEF DESCRIPTION OF THE DRAWINGS

FIG. 1 is an electron scanning microscope image of a porous nanosheet according to an exemplary embodiment of the present invention.

FIG. 2 is a graph showing an X-ray diffraction pattern of the porous nanosheet according to an exemplary embodiment of the present invention.

FIG. 3 is a transmission electron microscope image of the porous nanosheet according to an exemplary embodiment of the present invention.

FIG. 4 is a scanning transmission electron microscope image of the porous nanosheet according to an exemplary embodiment of the present invention.

FIG. 5 is a graph in which hydrogen evolution reaction (HER) catalytic activity results of the porous nanosheet according to an exemplary embodiment of the present invention are analyzed.

FIG. 6 is a graph in which XANES/EXAFS of the porous nanosheet according to an exemplary embodiment of the present invention is analyzed.

### DETAILED DESCRIPTION OF EMBODIMENTS

Hereinafter, exemplary embodiments of the present invention will be described in detail so as to be easily practiced by a person skilled in the art to which the present invention pertains. The present invention may be implemented in various different forms, and is not limited to the exemplary embodiments described herein.

As described above, for optimal performance of a single atom catalyst, substrates need conditions such as high electroconductivity, a rapid ion diffusion rate, strong bonding with a single atom, and chemical stability, but conventionally an electrochemical catalyst using it does not obtain efficiency and economic feasibility to replace platinum due to low electrical properties, a structural stability problem, or a problem of not showing sufficient catalyst efficiency.

Thus, the present invention provides a method for manufacturing a porous nanosheet including: a first step of manufacturing a MoS₂ nanosheet; a second step of heat-treating the MoS₂ nanosheet under a nitrogen atmosphere to manufacture a MoN nanosheet; and a third step of reacting the MoN nanosheet with a solution including platinum to manufacture a Pt—MoN nanosheet to which platinum is introduced, thereby presenting a solution to the problems described above.

Thus, since the present invention may include holes on the surface while maintaining a two-dimensional nanosheet form and may significantly improve catalyst efficiency and economic feasibility while minimizing platinum usage by introducing a platinum single atom to the holes, a catalyst which is more economical and has better efficiency than currently commercially available Pt/C may be manufactured.

Hereinafter, the method for manufacturing a porous nanosheet according to the present invention will be described.

The method for manufacturing a porous nanosheet according to the present invention includes: a first step of manufacturing a MoS₂ nanosheet, a second step of heat-treating the MoS₂ nanosheet under a nitrogen atmosphere to manufacture a MoN nanosheet, and a third step of reacting the MoN nanosheet with a solution including platinum to manufacture a Pt—MoN nanosheet to which platinum is introduced.

The first step of the method for manufacturing a porous nanosheet according to the present invention is a step of manufacturing a MoS₂ nanosheet.

Recently, in an electrical/photocatalytic material which plays a key role in various renewable energy technologies, performance improvement and precious metal usage are induced by attempts such as reducing a precious metal particle size together with methods such as a band structure, porosity adjustment, conductivity control, amorphization, and defect structure production of a catalyst material, in order to replace or decrease the usage of a conventional high-priced precious metal catalyst material. In particular, when a catalyst is manufactured in a single atom form with a precious metal, all atoms may theoretically function as a surface active site and may show very high activity per weight, and thus, a method of introducing a precious metal single atom to a nanosheet in a two-dimensional form to which holes are introduced is in the spotlight.

However, since a single atom state has very high surface energy and tends to easily agglomerate, strong fixation to substrates is needed in order to prevent agglomeration, but a technology of preventing agglomeration of a single metal atom while maintaining a nanosheet form structure has never been introduced so far.

Meanwhile, when the substrate has a nanosheet form having holes, a diffusion rate of ions and materials is improved and a site to which a precious single atom is strongly bonded may be provided by the defect. Thus, in the present invention, a plurality of MoS₂ nanosheet precursors having a layered structure are laminated again with a material including an organic cation to form a MoS₂ nanosheet in a house-of-card form in the first step, and a MoN nanosheet having holes formed by a heat treatment under a nitrogen atmosphere is implemented to strongly bond the agglomeration of a single metal atom by the defect in the second step, and thus, the above-described problem was overcome.

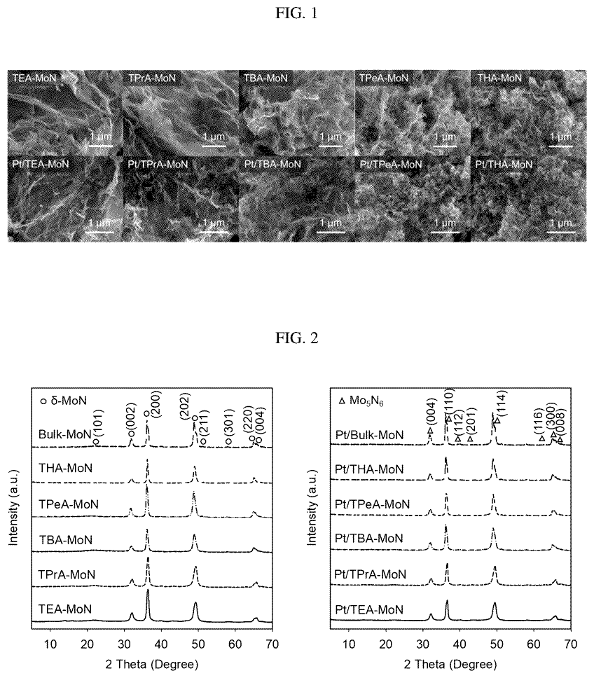

More specifically, referring to FIG. 1 which is an electron scanning microscope image (FE-SEM), it may be confirmed that holes are formed in the MoN nanosheet according to the present invention manufactured in the first and second steps. In addition, as the size of interlayer ions increases, it may be confirmed that the laminate structure of the two-dimensional nanosheet becomes more irregular and more damage occurs. However, it is shown that a porous two-dimensional nanosheet is still maintained.

In addition, referring to FIG. 2 showing an X-ray diffraction pattern, it may be confirmed that in the MoN nanosheets according to the present invention manufactured in the first and second steps, a δ-MoN phase and a Mo₅N₆ phase are mixed regardless of the type of interlayer ions. In addition, it may be confirmed that the Pt—MoN nanosheet to which a platinum single atom is introduced by the third step described later shows both of two phases, but the X-ray diffraction peak by the Mo₅N₆ phase is stronger as compared with the nanosheet before hybridization. Meanwhile, it is shown that Pt metal particles are not formed and bonded to the Pt—MoN nanosheet from the fact that no X-ray diffraction pattern by the Pt metal is shown.

To this end, in the first step, it may be manufactured by a common method for manufacturing a MoS₂ nanosheet as long as it serves the purpose of the present invention to manufacture the MoS₂ nanosheet, and thus, it is not particularly limited. For example, step 1-1 of mixing MoS₂ with n-butyllithium solution (1.6 M in hexane) and performing a reaction for 10 to 100 hours to synthesize LiMoS₂ in which a Lit ion is inserted between layers, and then removing n-butyllithium, and step 1-2 of adding the synthesized LiMoS₂ to distilled water and dispersing the mixture with ultrasound for 0.5 to 2 hours to obtain MoS₂ nanosheet precursor colloids from which MoS₂ is peeled off may be performed. Thereafter, step 1-3 of obtaining the MoS₂ nanosheet in which the obtained MoS₂ nanosheet precursor colloids are laminated with a material including an organic cation may be performed.

Herein, when a MoS₂ nanosheet in which the MoS₂ nanosheet precursor colloids are not laminated with an organic cation is used in the first step, a sufficient surface active site may not be secured to deteriorate catalyst efficiency.

Meanwhile, the material including an organic cation may be a commonly known material including an organic cation which may be laminated or interposed using electrostatic attraction between a plurality of MoS₂ nanosheet precursors to laminate the MoS₂ nanosheet, and as a non-limiting example, the material including an organic cation may use tetraalkylammonium ion, more preferably, may use among the tetraalkylammonium ion, tetraehtylammonium hydroxide (TEAOH), tetrapropylammonium hydroxide (TPrAOH), tetrabutylammonium hydroxide (TBAOH), tetrapentylammonium hydroxide (TPeAOH), or tetrahexylammonium hydroxide (THAOH), and most preferably, may use tetrapropylammonium hydroxide (TPrAOH).

As such, in order to form holes in the MoS₂ nanosheet in a two-dimensional form manufactured in the first step, the MoS₂ nanosheet may be heat-treated with ammonia gas at a temperature of 700 to 900° C. in the second step, and more preferably, may be heat-treated with the ammonia gas at a temperature of 750 to 850° C. As a method of forming holes by heat-treating the MoS₂ nanosheet under the ammonia gas atmosphere as such, a known heat treatment method which serves the purpose of the present invention may be used, and preferably, the heat treatment may be performed for 1 hour while the ammonia gas flows at a flow rate of 50 to 200 sccm in the MoS₂ nanosheet obtained in the first step, the heat treatment temperature is 700 to 900° ° C., and a heating rate is maintained at 200° C./h. Herein, when the temperature of the heat treatment in the second step is lower than 700° C., a phase change into MoN may not occur or surface pores may not be sufficiently formed, and when the temperature of the heat treatment in the second step is higher than 900° C., nitrides other than targeted MoN may be formed or the structure may be severely damaged.

Meanwhile, the heat treatment is performed under the ammonia gas atmosphere in the second step, thereby manufacturing a MoN nanosheet in which sulfur is substituted with nitrogen, and in this case, a surface anion defect is formed by the substitution of sulfur with nitrogen, which may be favorable for hybridization of other nanostructures and improves conductivity, and thus, it may be advantageous when it is used as an electrocatalyst and an electrode material.

Next, the third step of the method for manufacturing a porous nanosheet according to the present invention is a step of reacting the MoN nanosheet with a solution including platinum to manufacture a Pt—MoN nanosheet to which platinum is introduced.

In general, for optimal performance of a metal single atom catalyst, substrates need conditions such as high electroconductivity, a rapid ion diffusion rate, strong bonding with a single atom, and chemical stability. In the present invention, a MoN nanosheet to which holes are introduced by the first and second steps is manufactured, thereby forming the defect, preventing agglomeration of a metal single atom and strongly bonding the metal single atom with the nanosheet. However, introduction of the metal single atom to the nanosheet greatly deteriorates structural stability of the nanosheet by mixing two materials, apart from improvement of catalytic properties such as electroconductivity, so that electrochemical stability may not be secured.

Thus, the present invention implements Pt—MoN to which a platinum single atom is introduced by a substitution reaction between a platinum (Pt) ion and a molybdenum (Mo) ion of MoN in the third step, thereby solving the problem described above.

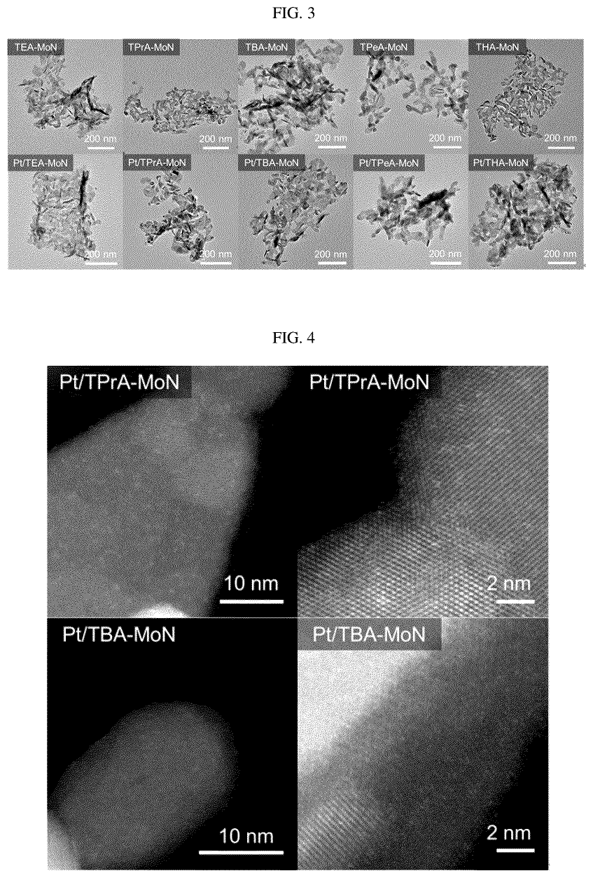

More specifically, referring to FIG. 3 which is a transmission electron microscope (TEM) image in which platinum as a metal single atom is introduced to the MoN nanosheet by the third step according to the present invention, it may be confirmed to be a form in which holes are introduced to a thin nanosheet as shown in the electron scanning microscope image described above, and to maintain the structure relatively well even after hybridization with a platinum atom.

In addition, even from the scanning transmission electron microscope (STEM) image of FIG. 4, it may be confirmed that an atom shown as a brighter dot is a platinum atom and is uniformly fixed to the MoN nanosheet without an agglomerated part in a particle form.

As such, in the present invention, in the third step, the MoN nanosheet may be stirred with a H₂PtCl₆ aqueous solution at a temperature of 60 to 80° C. for 1 to 3 hours for introducing the metal single atom to the two-dimensional nanosheet. Herein, when the third step is performed at a temperature lower than 60° C., the platinum atom may not be sufficiently substituted, and also, when the third step is performed at a temperature higher than 80ºC, the nanosheet structure may be destroyed due to a rapid substitution reaction. Next, the porous nanosheet according to the present invention will be described.

However, descriptions of the parts with the same technical idea as the method for manufacturing a porous nanosheet will be omitted for avoiding overlapping.

The present invention provides a porous nanosheet in which holes are included on the surface and a platinum atom is introduced to a part of the holes, as a MoN nanosheet. Herein, according to an exemplary embodiment of the present invention, the porous nanosheet may be characterized in that an XRD 2-theta value by a platinum single metal is not shown.

More specifically, referring to FIG. 2 showing an X-ray diffraction pattern of the porous nanosheet according to an exemplary embodiment of the present invention, the X-ray diffraction pattern by the platinum single metal is not shown. Thus, it is shown that the platinum metal particles did not agglomerate and the platinum single atom is bonded to the nanosheet in a Pt—MoN nanosheet form.

Meanwhile, the present invention provides an electrochemical catalyst including the porous nanosheet, and the electrochemical catalyst may be used as a catalyst in a hydrogen evolution reaction (HER).

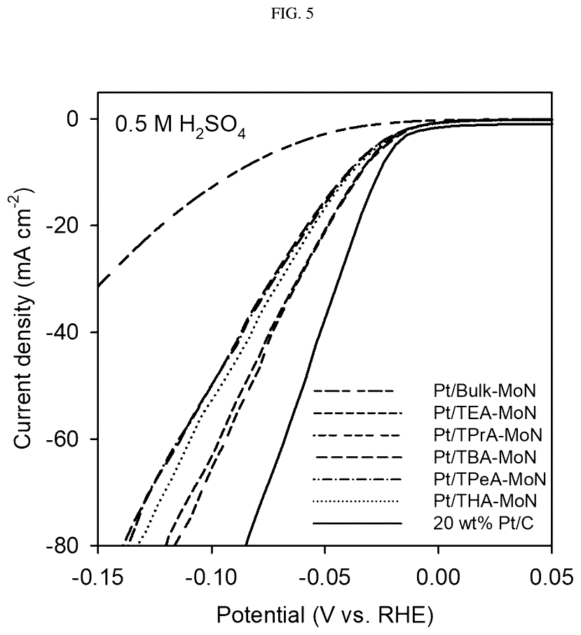

More specifically, referring to FIG. 5 which is a hydrogen evolution reaction (HER) catalytic activity result data for the porous nanosheet according to an exemplary embodiment of the present invention, the hydrogen evolution catalytic activity of Pt/TPrA-MoN synthesized by lamination with TPrA was best, which is greatly improved performance as compared with Pt/Bulk-MoN having no porous nanosheet structure. Thus, it may be confirmed that since the porous nanosheet according to the present invention may show a catalytic activity similar to a commercialized platinum-based catalyst even with a small platinum amount, platinum usage is minimized and catalyst efficiency and economic feasibility may be significantly improved, and thus, a catalyst which is more economical and has better efficiency than currently commercialized Pt/C may be manufactured.

Hereinafter, the present invention will be described in more detail by the examples, but the following examples do not limit the scope of the present invention and should be construed to help understanding of the present invention.

### Example 1—Manufacture of Porous Nanosheet

A MoS₂ nanosheet was synthesized by the following method.

MoS₂ was mixed with n-butyllithium solution (1.6 M in hexane) and a reaction was performed for 72 hours to form LiMoS₂ in which a Lit ion is interposed between layers, which was washed with hexane to remove remaining n-butyllithium. Thereafter, synthesized LiMoS₂ was added to distilled water and dispersed with ultrasound for 1 hour to peel off MoS₂, thereby obtaining nanosheet colloids. To the obtained MoS₂ nanosheet colloids, tetraethyl ammonium hydroxide (alkyl: ethyl, propyl, butyl, pentyl, or hexyl) as a cation material was added, stirring was performed to laminate the MoS₂ nanosheet with a tetraethyl ammonium cation, and the obtained precipitate was sufficiently washed with water and freeze-dried.

The MoN nanosheet was manufactured by the following method.

A heat treatment was performed while NH₃ gas was flowed at a flow rate of 100 sccm in the obtained MoS₂ nanosheet, and the temperature of the heat treatment was performed at 800° C. and a heat treatment heating rate was 200° C./h.

A final porous nanosheet was manufactured by the following method.

The obtained MoN nanosheet was added to tertiary distilled water and dispersed with ultrasound for 1 hour to form a uniform suspension. Thereafter, a 1 mM H₂PtCl₆ aqueous solution was added to the suspension made in advance and stirring was performed to mix the two solutions uniformly. While the mixed solution was stirred at 70° C. for 2 hours in a sealed state so that water vapor was not able to escape, a MoN nanosheet to which a Pt single atom was introduced by a substitution reaction between a Pt ion and a Mo ion of MoN was synthesized.

### Examples 2 to 5—Manufacture of Porous Nanosheet

Porous nanosheets were manufactured in the same manner as in Example 1, except that tetrapropyl ammonium hydroxide, tetrabutyl ammonium hydroxide, tetrapentyl ammonium hydroxide, and tetrahexyl ammonium hydroxide were used as the cation material, as listed in the following Table 1.

### Comparative Example 1

A porous nanosheet was manufactured in the same manner as in Example 1 except that MoS₂ was not peeled off in the manufacture of the MoS₂ nanosheet.

TABLE 1

| | | | | | | Comparative |
|---|---|---|---|---|---|---|
| Classification | Example 1 | Example 2 | Example 3 | Example 4 | Example 5 | Example 1 |
| Before platinum | TEA-MoN | TPrA-MoN | TBA-MoN | TPeA-MoN | THA-MoN | Bulk-MoN |
| introduction | | | | | | |
| Platinum introduced | Pt/TEA-MoN | Pt/TPrA-MoN | Pt/TBA-MoN | Pt/TPeA-MoN | Pt/THA-MoN | PtBulk-MoN |

### Experimental Example 1—SEM Image

Electron scanning microscope images (Field Emission-Scanning Electron Microscopy, available from JEOL JSM-7001F) were confirmed for the above examples, and are shown in FIG. 1.

Referring to FIG. 1, it is confirmed that holes were formed in the MoN nanosheets of all of the examples. However, as the size of interlayer ions increased, it is confirmed that the laminate structure of the two-dimensional nanosheet became more irregular and more damage occurred. However, in the case of Pt—MoN, it is shown that there was a little more nanosheet structure damage, but the porous two-dimensional nanosheet structure was still maintained.

### Experimental Example 2—X-Ray Diffraction Pattern Analysis

X-ray diffraction patterns (available from Rigaku/MiniFlex) for the examples were analyzed, and are shown in FIG. 2.

Referring to FIG. 2, it is shown that a δ-MoN phase and a Mo₅N₆ phase were mixed regardless of the type of interlayer ions in all of the examples. At this time, it was confirmed that the Pt—MoN nanosheet to which a platinum single atom is introduced showed both of two phases, but the X-ray diffraction peak by the Mo₅N₆ phase was stronger as compared with the nanosheet before hybridization. In addition, it is shown that Pt metal particles were not formed by the fact that the X-ray diffraction pattern by the Pt metal was not shown.

### Experimental Example 3—TEM Image

For the above example, transmission electron microscope images were confirmed and are shown in FIG. 3.

Referring to FIG. 3, it is confirmed to be a thin nanosheet form to which holes were introduced, as shown in the electron scanning microscope image, and maintain the structure relatively well even after hybridization with a Pt atom.

### Experimental Example 4—STEM Image

For the above examples, scanning transmission electron microscope images were confirmed and are shown in FIG. 4.

Referring to FIG. 4, it is confirmed that an atom shown as a brighter dot was a platinum atom and was uniformly fixed to the MoN nanosheet without an agglomerated part in a particle form.

### Experimental Example 5—Hydrogen Evolution Reaction (HER) Performance Measurement

The hydrogen evolution reaction (HER) catalytic activity results for the examples were analyzed, and are shown in FIG. 5. For the examples, electrochemical catalyst measurement was performed in a 0.5 M H₂SO₄ solution, and a scan rate was 5 mV/s.

Referring to FIG. 5, as a result of measurement, it was confirmed that the hydrogen evolution catalytic activity of Pt/TPrA-MoN synthesized by lamination with TPrA was the best, showed greatly improved performance as compared with Pt/Bulk-MoN which does not have a porous nanosheet structure, and had catalytic activity similar to that of a commercialized platinum-based catalyst even with a small platinum amount.

### Experimental Example 6—XANES/EXAFS Analysis

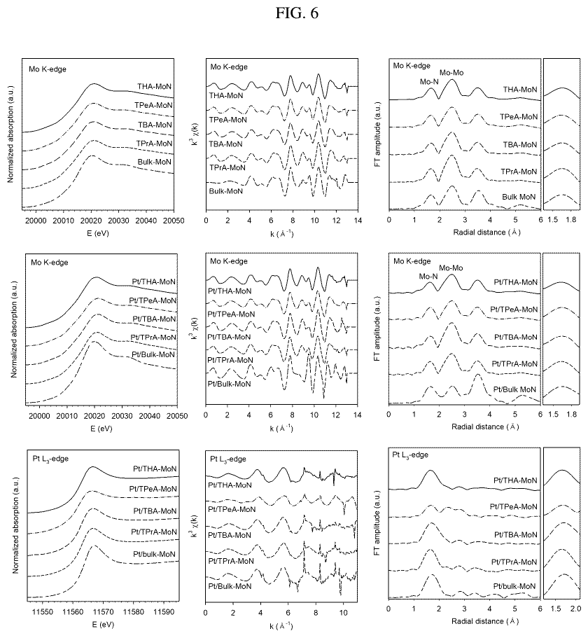

Referring to FIG. 6, as seen in the results of XANES/EXAFS, as the size of interlayer ion increased, the number of coordination of Mo—N bonds decreased, and thus, it is confirmed that more defects were introduced when the MoS₂ nanosheet to which a larger interlayer ion was introduced was heat-treated. In addition, the same tendency was shown in Pt—MoN. Additionally, since a peak by a Pt—Pt bond was not observed and only a peak by a Pt—N bond was observed in Pt L₃-edge EXAFS, it is confirmed that the platinum atom was uniformly distributed in the MoN nanosheet in a single atom form, not in a particle form.

To sum up the experimental examples as such, since the porous nanosheet according to the present invention may include holes on the surface while maintaining a two-dimensional nanosheet form and may significantly improve catalyst efficiency and economic feasibility while minimizing platinum usage by introducing a platinum single atom to the holes, a catalyst which is more economical and has better efficiency than currently commercially available Pt/C may be manufactured.

What is claimed is:

1. A method for manufacturing a porous nanosheet comprising:
a first step of manufacturing a MoS₂ nanosheet;
a second step of heat-treating the MoS₂ nanosheet under a nitrogen atmosphere to manufacture a MoN nanosheet; and
a third step of reacting the MoN nanosheet with a solution including platinum to manufacture a Pt—MoN nanosheet to which platinum is introduced.

2. The method for manufacturing a porous nanosheet of claim 1, wherein the MoS₂ nanosheet of the first step is formed by laminating a plurality of MoS₂ nanosheet precursors with a material including an organic cation.

3. The method for manufacturing a porous nanosheet of claim 1, wherein the second step is heat-treating the MoS₂ nanosheet with an ammonia gas at a temperature of 700 to 900° C.

4. The method for manufacturing a porous nanosheet of claim 1, wherein the second step is forming holes by the heat treatment.

5. The method for manufacturing a porous nanosheet of claim 1, wherein the third step is stirring the MoN nanosheet with a H₂PtCl₆ aqueous solution at a temperature of 60 to 80° C. for 1 to 3 hours.

6. The method for manufacturing a porous nanosheet of claim 1, wherein the third step is manufacturing the Pt—MoN nanosheet to which a platinum single atom is introduced by a substitution reaction between a platinum (Pt) ion and a molybdenum (Mo) ion of MoN.

7. A porous nanosheet which is a MoN nanosheet, comprising holes on the surface, wherein a platinum atom is introduced to a part of the holes.

8. The porous nanosheet of claim 7, wherein an XRD 2-theta value by a platinum single metal is not shown.

9. An electrochemical catalyst comprising the porous nanosheet of claim 7.

10. The electrochemical catalyst of claim 9, wherein the electrochemical catalyst is used as a catalyst in a hydrogen evolution reaction (HER).
